(19) United States
(12) Patent Application Publication
(10) Pub. No.: US 2004/0178315 A1
(43) Pub. Date: Sep. 16, 2004

(54) PROBE HOLDER

(76) Inventor: TIEK-NYEN LEE, Penang (MY)

Correspondence Address: NAIPO (NORTH AMERICA INTERNATIONAL PATENT OFFICE), P.O. BOX 506, MERRIFIELD, VA, 22116, US

(21) Appl. No.: 10/708,305

(22) Filed: Feb. 24, 2004

(30) Foreign Application Priority Data
Mar. 13, 2003 (MY) PI20030880

(51) Int. Cl. A62B 7/10; F16B 47/00

(52) U.S. Cl. 248/363

(57) ABSTRACT

A probe holder includes a body; an air inlet positioned on the body for inputting an air flow; a first airway embedded in the body and connected to the air inlet for providing a conduit for the air flow; a second airway embedded in the body and connected to the first airway; a vacuum cup positioned on the body and connected to the second airway, the vacuum cup being used to contact a surface to provide suction at the surface; an air outlet positioned on the body and connected to the first airway for venting the air flow; and a holding portion installed on the body for holding a testing probe.

### BACKGROUND OF INVENTION

1. Field of the Invention

The invention relates to a probe holder, and more particularly, to a probe holder for attaching a testing probe onto a surface utilizing suction generated by an air flow.

2. Description of the Prior Art

In the last decade, the focus of electronic products has migrated from dedication to purely computational tasks to multi-media applications. Accordingly, demands on the quality and quantity of display devices have grown and that, as a result, has benefited the display panel manufacturing industry.

In order to insure that all the display devices (for example, CRT monitors, LCD monitors, LCD panels of PDAs, etc) put on the shelves are quality products, it is critical that a testing procedure is provided after the display panels have been manufactured. By doing so, those panels with flaws can be located, and fixed or discarded as the situation allows. Conventionally, the testing procedure is executed by utilizing a testing probe. A testing engineer performing the testing procedure grasps the testing probe with his or her hands and moves the testing probe sequentially past every corner of the panel to be tested. The testing probe then captures a display result of the panel and an analysis can be done based upon these results. This analysis is used to determine if the tested panel is a product with suitable quality.

However, physically grasping the testing probe has several major disadvantages. One of them is that human body movements are imprecise and undependable. Holding the testing probe with only the hands during the testing procedure may generate errors in testing results due to random factors generic to the human body, such as respiration, muscle trembling, etc. Moreover, since the testing procedure is a repetitive, exhausting job, after long testing periods, the testing engineer tends to more easily generate errors during the testing procedure due to physical exhaustion. All of these factors mentioned above cause a drop in testing efficiency, which is not desirable during the testing procedure.

### SUMMARY OF INVENTION

It is therefore a primary objective of the claimed invention to provide a testing probe holder to solve the above-mentioned problems.

According to the claimed invention, a probe holder for holding a testing probe comprises a body; an air inlet positioned on the body for inputting an air flow; a first airway embedded in the body and connected to the air inlet at a first opening of the first airway for providing a conduit for the air flow; a second airway embedded in the body and connected to a second opening of the first airway at a fourth opening of the second airway; a vacuum cup positioned on the body and connected to a fifth opening of the second airway, the vacuum cup adapted for contacting a surface to provide suction at the surface; an air outlet positioned on the body and connected to a third opening of the first airway for outputting the air flow; and a holding portion installed on the body for holding the testing probe.

The present invention probe holder includes a first airway as a conduit for an air flow, a second airway as connection between the first airway and a vacuum cup, and the vacuum cup for contacting a surface to provide suction at the surface. According to Bernoulli”s theorem, a low-pressure condition is generated in the second airway and at the vacuum cup when the air flow flows through the first airway under the above-mentioned setup. The present invention probe holder further includes a holding portion for holding a testing probe. Together, the testing probe can attach to a surface to be tested easily and steadily, and the problem shown in the prior art is resolved by utilizing the present invention probe holder.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a probe holder according to the present invention when an air flow is vented at an air outlet.

FIG. 2 illustrates detaching a vacuum cup depicted in FIG. 1 according to the present invention.

FIG. 3 is a diagram of an air outlet actuator according to present invention.

FIG. 4 is an operating diagram of a probe holder according to present invention when the probe holder attaches to a surface to be tested.

FIG. 5 is a diagram of a preferred embodiment of a probe holder according to the present invention.

### DETAILED DESCRIPTION

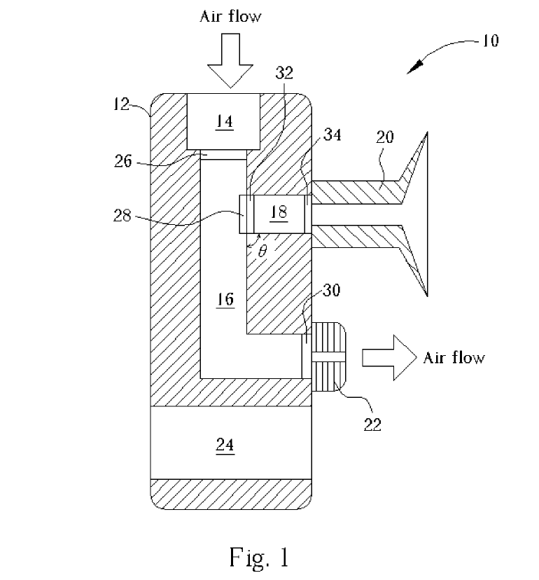

Please refer to FIG. 1. FIG. 1 is a diagram of a probe holder 10 according to present invention when an air flow is vented at an air outlet. In FIG. 1, the probe holder 10 comprises a body 12; an air inlet 14 positioned on the body 12 for inputting an air flow, as shown in the figure; a first airway 16 embedded in the body 12 and connected to the air inlet 14 at a first opening 26 of the first airway 16 for providing a conduit for the air flow; a second airway 18 embedded in the body 12 and connected to a second opening 28 of the first airway 16 at a fourth opening 32 of the second airway 18; a vacuum cup 20 positioned on the body 12 and connected to a fifth opening 34 of the second airway 18. The vacuum cup 20 is adapted for contacting a surface (not shown in FIG. 1) to provide suction at the surface; an air outlet 22 positioned on the body 12 is connected to a third opening 30 of the first airway 16 for venting the air flow, as shown in the figure; and a holding portion 24 is installed on the body 12 for holding a testing probe (not shown in FIG. 1).

For the present invention, the air inlet 14, the first airway 16, and the second airway 18 can be tubes installed inside the body 12, and such a setup also falls within the scope of the claimed present invention. Furthermore, the holding portion 24 can be a receiving space in the body 12 for inserting the testing probe. Alternatively, the holding portion 24 may be a clamp affixed to the body 12 for holding a probe (not shown), or the like. It should be understood that these exemplary setups are given as preferred embodiments and are not meant to be limiting.

According to Bernoulli”s theorem, when the air flow flows from the air inlet 14 through the first airway 16, and is vented at the air outlet 22, a low pressure condition is generated in the second airway 18, and hence in the vacuum cup 20. At this time, in conjunction with a rim of the vacuum cup 20 being in proper contact with a surface (which can be, for example, a display panel to be tested), suction at the surface, strong enough to endure the weight of the probe holder 10 plus the weight of the testing probe, is provided by the air flow flowing through the first airway 16. Hence, in order to successfully provide the suction needed, the second airway 18 is connected to the first airway 16 with an angle θ₁ (as shown in FIG. 1) such that the air flow through the first airway 16 generates a desired low pressure condition in the second airway 18 and in the vacuum cup 20.

To accomplish the goal mentioned above, the angle θ₁ of the second airway 18 to a direction of the air flow through the first airway 16 flowing past the second airway 18 is preferably equal to or larger than ninety degrees. An inner diameter of the air inlet 14 is preferably larger than an inner diameter of the first airway 16, such that an air pressure of the air flow increases as long as the air flow passes the first opening 26 and flows inside the first airway 16. Furthermore, an inner diameter of the second airway 18 is preferably smaller than an inner diameter of the first airway 16. All these preferable conditions stated above in this paragraph contribute to the same goal of ensuring the generation of the low-pressure condition in the second airway 18 and in the vacuum cup 20.

Also, in order to provide the air flow flowing in the first airway 16, an air flow input is installed at the air inlet 14, and the air flow input at the air inlet 14 is capable of being connected to a compressed air source. The air flow input can be, for example, an air tube that is adapted to be connected to an air hose coming out of the compressed air source.

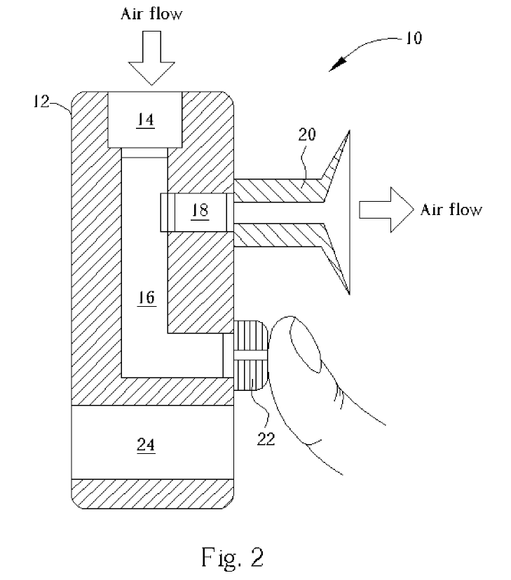

The operating principles for attaching the probe holder 10 to a surface have been described in previous paragraphs. Now please refer to FIG. 2, which illustrates the operating principles of detaching the probe holder 10 from a surface. FIG. 2 is a diagram of the probe holder 10 in FIG. 1 according to present invention when the air flow is blocked at the air outlet 22. Now consider a situation that the probe holder 10 has been attached to a surface by way of the vacuum cup 20 due to the air flow. As shown in FIG. 2, at this time if the air flow is flowing from the air inlet 14 through the first airway 16, but now the air outlet 22 is blocked (for example, by a finger), the air flow then has no choice but to flow out of the first airway 16 through the second airway 18 and the vacuum cup 20. This phenomenon creates a high pressure condition rather than a low one in the second airway 18 and in the vacuum cup 20, and as a result, suction at the vacuum cup 20 is no longer provided. This achieves the goal of detaching the probe holder 10 from the surface. Of course, even partially blocking the air outlet 22 may be sufficient to eliminate the suction within the vacuum cup 20, and hence detach the probe holder 10 from the surface.

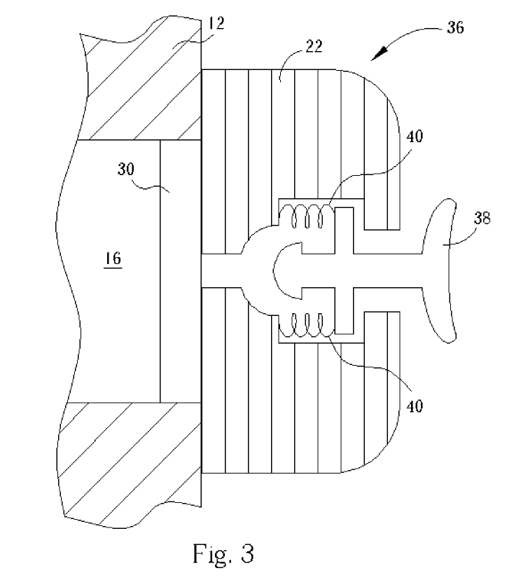

In order to permit modifying of venting of the air outlet 22, the air outlet 22 is designed to be capable of being blocked by a finger. Also, the present invention probe holder 10 can further comprise an air outlet actuator installed on the air outlet 22 for controlling the outflow of the air flow from the air outlet 22. One example of such an air outlet actuator is given in FIG. 3. FIG. 3 is an air outlet actuator 36 according to present invention. The air outlet actuator 36 is installed on the air outlet 22 and comprises a blocking portion 38 and a plurality of springs 40 (in FIG. 3, there are two springs 40 shown). The blocking portion 38 has a pushing end adapted to be pushed by a finger, and a blocking end capable of fully blocking the venting of the air flow at the air outlet 22. The blocking portion 38 is connected to the air outlet 22 through the springs 40 in an elastic manner, as shown in FIG. 3. Please note, it should be understood that the air outlet actuator 36 in FIG. 3 is given as a preferred embodiment and is not meant to be limiting.

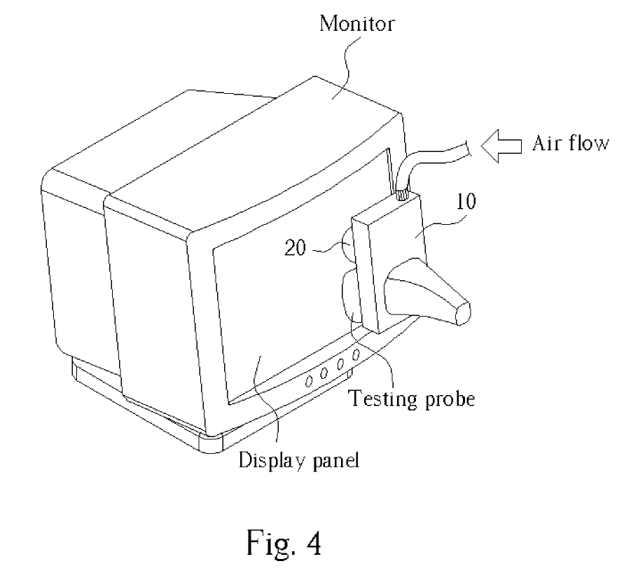

Please refer to FIG. 4. FIG. 4 is an operating diagram of a probe holder 10 according to the present invention when the probe holder 10 attaches to a surface to be tested. The surface to be tested can be a display panel under test, as shown in FIG. 4. Therefore, the vacuum cup 20 of the probe holder 10 is adapted to contact a display panel to be tested. According to FIG. 4, it is clear that through the use of the present invention probe holder 10 in conjunction with proper operation, a testing probe can be steadily and effortlessly attached to a surface (for example, a display panel) to be tested. Here, since the whole body of the present invention probe holder 10 has a high probability of getting close to or in contact with the display panel to be tested during operation, the body 12 of the probe holder 10 is preferably made of a non-metallic material to avoid possible damages (such as scratches) to the display panel, and the body 12 of the probe holder 10 is also preferably made of a non-magnetic material to avoid possible interference during testing read-outs.

Furthermore, please note that though FIG. 1 and FIG. 2 depict the air outlet 22, and therefore a direction of the second airway 18, being positioned on the same side of the body 12 as the vacuum cup 20, this does not preclude the possibility of the air outlet 22 being positioned at a different location of the probe holder 10 from that shown, and is considered an implementation choice.

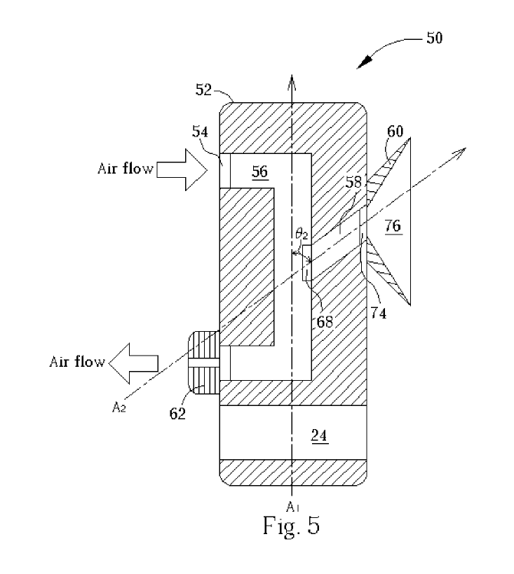

Please refer to FIG. 5. FIG. 5 is a diagram of a second preferred embodiment of a probe holder 50 according to the present invention. The probe holder 50 is used for attaching a testing probe affixed in the receiving space 24 onto a surface (not shown in FIG. 5). The probe holder 50 comprises a body 52, a first airway 56, a second airway 58, and a vacuum cup 60. The first airway 56 is formed within the body 52 and extending along a first axis A₁. The first airway 56 has an air inlet 54, an air outlet 62, and a midpoint opening 68. The midpoint opening 68 is formed between the air inlet 54 and the air outlet 62. The second airway 58 is formed within the body 52 and extending along a second axis A₂. The second airway 58 communicates with the first airway 56 through the midpoint opening 68, and the second airway 58 has a surface opening 74 formed on a surface of the body 52. The angle θ₂ defined between the first axis A₁ and the second axis A₂ is less than or equal to ninety degrees. The vacuum cup 60 is disposed around the surface opening 74. The vacuum cup 60 has an inner space 76 communicating with the second airway 58 through the surface opening 74. When an air flow is flowing from the air inlet 54 towards the air outlet 62, the air flow draws air from the second airway 58 through the midpoint opening 68, so that the air pressure of the inner space 76 of the vacuum cup 60 is reduced to allow attaching of the testing probe onto the surface. Note here that direction of the first axis A₁ and direction of the second axis A₂ are defined by arrowheads shown in FIG. 5, respectively, and the angle θ₂ is then defined accordingly.

Similar to the first preferred embodiment, the inner diameter of the second airway 58 is smaller than the inner diameter of the first airway 56. Besides, the diameter of the air outlet 62 is small enough, so the air outlet 62 is dimensioned to be substantially blocked by the operator's finger. When the air outlet 62 is blocked by operator's finger, then outflow of the air flow from the air outlet 58 is substantially reduced, and the air pressure within the vacuum cup 60 will increase. Further more, an air outlet actuator shown in FIG. 3 can be installed on the air outlet 62 for controlling the outflow of the air flow from the air outlet 58.

In contrast to the prior art, the present invention probe holder includes a first airway as a conduit for an air flow, a second airway as a connection between the first airway and a vacuum cup, and the vacuum cup for contacting a surface to provide suction at the surface. According to Bernoulli”s theorem, a low-pressure condition is generated in the second airway and at the vacuum cup when the air flow flows through the first airway. The present invention probe holder further includes a holding portion for holding a testing probe. Together, the testing probe can attach to a surface to be tested easily and steadily, and the problem noted in the prior art is resolved by utilizing the present invention probe holder.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. A probe holder for holding a testing probe, the probe holder comprising:
a body;
an air inlet positioned on the body, for inputting an air flow;
a first airway embedded in the body and connected to the air inlet at a first opening of the first airway for providing a conduit for the air flow;
a second airway embedded in the body and connected to a second opening of the first airway at a fourth opening of the second airway;
a vacuum cup positioned on the body and connected to a fifth opening of the second airway, the vacuum cup adapted for contacting a surface to provide suction at the surface;
an air outlet positioned on the body and connected to a third opening of the first airway for venting the air flow; and
a holding portion installed on the body for holding the testing probe.

2. The vacuum probe holder of claim 1 wherein the second airway is connected to the first airway with an angle such that the air flow through the first airway generates a low pressure condition in the second airway and in the vacuum cup.

3. The vacuum probe holder of claim 2 wherein the angle of the second airway to a direction of the air flow through the first airway flowing past the second airway is equal to or larger than ninety degrees.

4. The vacuum probe holder of claim 1 wherein the first and the second airways are tubes.

5. The vacuum probe holder of claim 4 wherein an inner diameter of the air inlet being larger than an inner diameter of the first airway.

6. The vacuum probe holder of claim 4 wherein an inner diameter of the second airway is smaller than an inner diameter of the first airway.

7. The vacuum probe holder of claim 1 wherein the air outlet is capable of being blocked by a finger to modify outflow of the air flow from the air outlet.

8. The vacuum probe holder of claim 1 further comprising an air outlet actuator installed on the air outlet for controlling the outflow of the air flow from the air outlet.

9. The vacuum probe holder of claim 1 wherein the body is made of a non-metallic material.

10. The vacuum probe holder of claim 1 wherein the body is made of a non-magnetic material.

11. The vacuum probe holder of claim 1 wherein the holding portion is a receiving space in the body for inserting the testing probe.

12. A probe holder for attaching a testing probe onto a surface, the probe holder comprising:
a body;
a first airway formed within the body and extending along a first axis, the first airway having an air inlet, an air outlet, and a midpoint opening, the midpoint opening formed between the air inlet and the air outlet;
a second airway formed within the body and extending along a second axis, the second airway communicating with the first airway through the midpoint opening, the second airway having a surface opening formed on the body surface, an angle between the first axis and the second axis being less than or equal to ninety degrees; and
a vacuum cup disposed around the surface opening, the vacuum cup having an inner space communicating with the second airway through the surface opening;
wherein when an air flow is flowing from the air inlet toward the air outlet, the air flow draws air from the second airway through the midpoint opening so that the air pressure of the inner space of the vacuum cup is reduced to attach the testing probe onto the surface.

13. The probe holder of claim 12 wherein an inner diameter of the second airway is smaller than an inner diameter of the first airway.

14. The probe holder of claim 12 wherein the diameter of the air outlet dimensioned to be substantially blocked by a finger, so that the outflow of the air flow from the air outlet being substantially reduced when the air outlet being blocked by the finger.

15. The probe holder of claim 12 further comprising an air outlet actuator installed on the air outlet for controlling the outflow of the air flow from the air outlet.
